(19) United States
(12) Patent Application Publication
(10) Pub. No.: US 2002/0004825 A1
(43) Pub. Date: Jan. 10, 2002

(54) Methods and apparatus for distributing content teaser click-through traffic to web sites containing full content

(76) Inventor: Gregrey E. Lindberg, Chapel Hill, NC (US)

Correspondence Address: JENKINS & WILSON, PA, 3100 TOWER BLVD, SUITE 1400, DURHAM, NC, 27707, US

(21) Appl. No.: 09/880,206

(22) Filed: Jun. 13, 2001

Related U.S. Application Data
(60) Provisional application No. 60/211,142, filed on Jun. 13, 2000.

(51) Int. Cl. G06F 15/16

(52) U.S. Cl. 709/218; 709/227

(57) ABSTRACT

An improved method and apparatus for driving traffic to World Wide Web (Web) and wireless Internet sites using dynamically updated content teasers that link to the full content is provided. Updated content teasers are presented to users through electronic mail readers, Internet browsers, or on wireless Internet devices. Readers who click on the content teasers are dynamically linked to any one of a network of sites where they may read the full content. When the user of the system clicks on a content teaser to request the full version of the content, the system queries a central program and database for instructions on which site to refer the user to for the full version of the content. In this manner, click-through traffic originating from a single site or network of sites can be distributed to a single site or a multitude of sites according to a predetermined computer algorithm. An apparatus for dynamically updating teaser content displays allows the simultaneous updating of teaser content displays in electronic mail readers, Internet browsers, or on wireless Internet devices while linking these headlines to the full content which dynamically appears at the same time on a network of sites. In this manner, both the teaser content and the full content simultaneously appear on parallel networks of sites.

### RELATED APPLICATIONS

This application claims the benefit of U.S. Provisional Patent Application No. 60/211,142, filed Jun. 13, 2000, the disclosure of which is incorporated herein by reference in its entirety.

### TECHNICAL FIELD

The present invention relates generally to the distribution of content teasers, such as news headlines, article summaries, and video or audio snippets, over a computer network for display in electronic mail readers, on Internet browsers, or on wireless Internet devices, and to the dynamic distribution of click-through traffic from those content teasers to a single site within a multitude of sites that display the full content.

### RELATED ART

In recent years, the use of the Internet as advertising medium has increased dramatically. The growth in both the number of advertisers and the number of web sites offering advertising space has led to increased competition for click-through traffic, and a search for ways to improve the click-through rate of Internet-based advertising. As used herein, the phrase “click-through traffic” refers to user queries to a web site using an input device, such as a keyboard or a mouse. As used herein, the phrase “click-through rate” refers to the number of instances of click-through traffic to a web site per unit time.

Most web site owners that sell advertising space do so by allowing advertisers to place “banner advertisements” on their sites. As used herein, the phrase “banner advertisement” refers to a graphical, textual, or graphical and textual identifier on a web site that displays information to the user and that, in response to click-through traffic, redirects an Internet navigation device to the advertiser's web site using a static HTML tag that links the banner advertisement to the advertiser's web site. As used herein, the term Internet navigation device means a web browser (such as Internet Explorer or Netscape Navigator), electronic mail reader (such as Microsoft Outlook), wireless Internet device (such as Palm Pilot VII), or other device or programmed computer for navigating the Internet.

While banner advertisements have been designed to include animation and brief scripts that allow rolling content, banner advertisements are entirely prefabricated, and thus do not change from day to day. In essence, banner advertisements age quickly, and thus provide little incentive for viewers to click on them. In addition, in light of the increasing number of banner advertisements on nearly every web site, users are predisposed to ignore banner advertisements. Finally, because banner advertisements do not lead to useful information, users have no incentive to click on the banner advertisements.

With currently available technology, Java applets with scrolling news headlines can be loaded to web sites in the place of traditional HTML banner advertisements. However, using current methods and web design tools, updating on a daily basis a network of banner advertisements that contain content teasers such as news headlines and that link to the associated full content is time consuming, expensive, and not practical. There are no available applets that dynamically link these news headlines to associated news articles on a single site or network of sites such that when new full news articles are made available on the sponsoring site, the headlines in the banner advertisements are likewise updated. Because of this shortcoming of current methods, the headlines in the banner advertisements must be manually recompiled after the new or updated full content is made available.

Thus, another limitation of conventional banner advertisements is that conventional banner advertisements cannot be updated to provide fresh content on a network of web sites without a substantial amount of work.

The static nature of online banner advertising explains why such advertising has continued to decline in effectiveness as the Internet has matured. On the Web, users are seeking information rather than passively absorbing it, and thus, choose to avoid advertisements that do not provide the value they seek. Thus, there exists a need for novel methods and systems for providing dynamically-updated useful content on the Internet that users are likely to access.

### SUMMARY OF THE INVENTION

The present invention concerns a method for improving on the limitations of traditional banner advertising on the Web by automatically and simultaneously displaying advertisements with content teasers over a network of web sites that allows the reader, viewer or listener of such content teaser to click-through to a sponsoring site where the associated full content is made available. As used herein, the term “content teaser” means a brief summary, preview, title, headline or snippet of textual, graphic, audio or video content that describes or provides an example of associated full content. As used herein, the term “full content” means a full article, story, movie, picture, or other textual, graphic, audio or video content that is available on the World Wide Web.

Furthermore, the present invention allows the dynamic allocation of click-through traffic from an advertisement containing a current content teaser to a single site within a multitude of sponsoring sites that display the full article. This aspect of the invention is a significant improvement over current banner advertisements, which are pre-programmed to refer click-through traffic to a single web site or uniform resource locator (URL). By dynamically allocating click-through traffic to a multitude of URLs based on a specified computer algorithm, such as one of the methods described below, each web site in a network of sponsoring web sites (referred to herein as a sponsor network) can purchase a portion of the traffic from a given Internet advertisement. Dynamically allocating click-through traffic to multiple sponsoring web sites thus allows multiple advertisers to benefit from a single Internet advertisement, or single electronic mail broadcast.

Therefore, it is an object of the invention to provide an improved method and apparatus for generating and displaying advertisements on the Internet that allows such advertisements to automatically and simultaneously contain fresh, daily content teasers such as news headlines without each site that displays such advertisements having to update the advertisement on their site.

It is another object of the invention to provide a simultaneous web site display of the full content on a network of sponsor sites.

It is yet another object of the invention to render content teasers on each site in a network of feeder sites (referred to herein as a “feeder network”) that functions so that when a user clicks on a content teaser in any site within such feeder network, he/she is taken to a web site that displays the full content.

It is yet another object of the invention to provide a web server containing a database that determines the allocation of click-through traffic from sites within a feeder network to sites within a corresponding sponsor network that display the full content.

It is yet another object of the invention to provide a web server containing a database of content teasers that relate to the full content and also containing computer programs that simultaneously and automatically distributes the content teasers to participating sites within the feeder network.

It is yet another object of the invention to provide content teasers to an electronic mail list of advertising prospects which are taken to any number of a multitude of web sites displaying the full content within the sponsor network based on a predetermined method, such as one of the methods described below.

The objects described above function together in two primary ways: one, over a feeder network of web sites, and, two, through an electronic mail broadcast to a list of advertising prospects. These two functions are described further below.

In the first instance, a user browsing the Internet may encounter a content teaser on a web site or wireless Internet display on one of the web sites within the feeder network. The user then clicks on the headline and is taken to another web site that receives click-through traffic according to a predetermined method, such as one of the methods described below. This second web site also displays the full content that is associated with the content teaser clicked on by the user. The term “live advertisement” or “live ad” as used herein means a dynamically generated graphical, textual, audio, or video identifier on an Internet navigation device that displays a content teaser to the user and that, in response to click-through traffic, redirects an Internet navigation device to any one of a multitude of web sites in the sponsor network.

When packaged into the space traditionally reserved for the banner advertisement, live advertisements can deliver substantially more value than traditional banner advertisements. Specifically, the live advertisement:

(a) self selects the appropriate demographic segment, i.e. users who click-through a live advertisement will be interested in the specific topic area relevant to the sponsor and covered by the advertisement's teaser content;

(b) avoids expensive and time-consuming profiling of readers to determine topics of interest to the readers. Simply put, if readers click on a teaser relevant to optometry practice management, then the readers are interested in that topic;

(c) side-steps privacy concerns encountered by companies that attempt to determine areas of user interest and then store data in a database;

(d) seamlessly integrates content with electronic commerce, avoiding the expensive task of trying to strategically place advertisements next to relevant content;

(e) cuts costs by avoiding advertising agency expense on “creative” graphics that do not add value to the end user;

(f) provides a firm action item to motivate click-through traffic as opposed to simple “display” banner advertisements;

(g) generates benefits even without a sponsor, making it more useful to web sites that cannot attract paying advertisers (for example, having daily headlines on a site may be better than no daily content at all); and

(h) always stays fresh, a significant advantage over banner advertising, which despite costing advertisers a significant amount to produce, declines in performance over time.

In the second instance, content teasers are sent via electronic mail broadcast to a prospect list. The email recipients on the list receive these content teasers and click-through to view the full content on a specific site that is predetermined by querying a server database.

This aspect of the invention allows multiple advertisers to take advantage of the prior business relationship that the electronic mail broadcaster has established with the prospect group receiving the electronic mail. In this manner, the user receives a single electronic mail every day containing content teasers, but a multitude of advertisers can benefit from that electronic mail by dynamic allocation of click-through traffic to their respective web sites based on a predetermined method, examples of which are described below. This is a significant improvement over the current practice of renting electronic mail lists to advertisers who do not have a prior business relationship with the targeted prospect, and thus are more likely to find their message ignored by the prospect.

Some of the objects of the invention having been stated hereinabove, other objects will be evident as the description proceeds, when taken in connection with the accompanying drawings as best described hereinbelow.

### BRIEF DESCRIPTION OF THE DRAWINGS

Preferred embodiments of the invention will now be explained with reference to the accompanying drawings, of which:

FIG. 1 is a block diagram illustrating the design of a feeder network of web sites that displays headlines to create live advertisements that allow users to click-through to sponsoring sites within a sponsor network according to an embodiment of the present invention;

FIG. 2 is a block diagram illustrating the dynamic allocation of click-through traffic by querying a central program and database to determine a site to which to refer the click-through traffic according to an embodiment of the present invention; and

FIG. 3 is a flow diagram of a system for dynamically allocating click-through traffic to a content web site according to an embodiment of the present invention.

### DETAILED DESCRIPTION OF THE INVENTION

This detailed description describes an embodiment of the invention involving news headlines and associated full news articles, it being understood by those skilled in the art that the invention described herein can be utilized with content teasers and full content involving digital content other than news, such as topical articles, stories, video content, audio content, pictures, photographs, and the like.

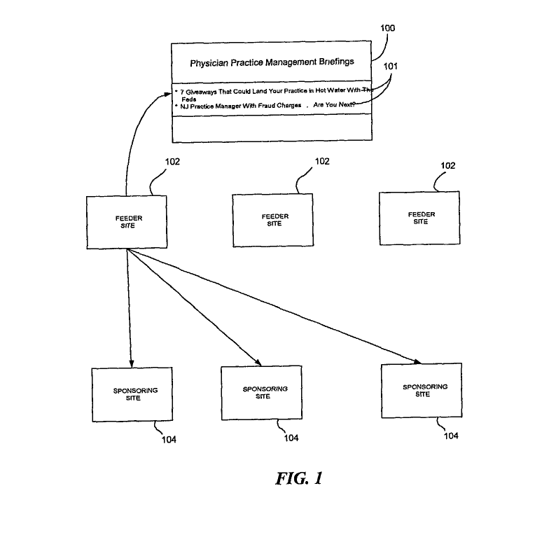

Referring initially to FIG. 1, a first embodiment of the present invention includes a live ad 100 for display of headlines 101 on an Internet navigation device. Headlines 101 are simultaneously and dynamically populated onto a network of referring sites, referred to herein as feeder sites 102. Live ads 100 may also be emailed to a list of advertising prospects who receive news headlines and are taken to one of a multitude of sponsoring web sites displaying the full content depending on a predetermined computer algorithm, such as the methods described below.

Each live ad 100 will link the reader to one or more sponsoring web sites for display of full content. The particular destination site of the user's click-through (where the user will read the full content) is determined by a computer algorithm. Another aspect of the present invention is to allow the full content to be displayed on sponsoring web sites 104 at the same time as the headlines are displayed on the network of feeder web sites 102.

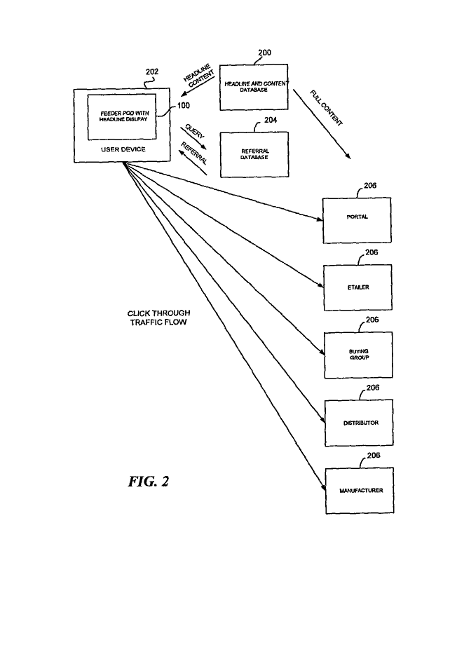

FIG. 2 illustrates an exemplary mechanism for dynamically allocating click-through traffic to full content display sites. FIG. 2 also illustrates an exemplary mechanism for updating headline content simultaneously with the corresponding full content. Referring to FIG. 2, the present invention includes a headline and content program and database 200 which may be stored on a web server. User device 202, such as a browser, an email reader, or wireless Internet device displays live ad 100 containing news headlines to a reader. When user clicks on live ad 100, user device 202 queries a referral program and database 204, which is programmed with an algorithm which determines the click-through path that the reader will take. Referral program and database 204 selects one of the sponsoring full content web sites served by content servers 206 and directs user device 202 to display that web site.

Referral program and database 204 may use any number of algorithms to select the content server 206 that will provide the full content of the article to the user. For example, referral program and database 204 may allocate a predetermined number of click-throughs to each web site. In another example, the content server may be selected by the user's profile. Such profile information can be obtained by reading cookies stored on user device 202. In yet another alternative, click-throughs may be distributed among content sites based on the time of day. For example, content sites A and B may receive all content referrals before 12 pm and content sites C and D may receive all referrals after 12 pm. In yet another alternative, click-throughs may be distributed to sites in a round robin fashion in which each site is allocated a predetermined number of content referrals and a turn. For example, site A, owned by the company that paid the most money, may receive the first 10 content referrals, followed by site B, owned by a company that paid the next highest amount of money, which may receive the next 5 content referrals. Such a scheme preferably continues until all content providers have received their referral allocation, then the referring starts over with site A.

In another example, referral program and database 204 may select a content server based on the headline on which the user clicks. For example, a live ad may contain two headlines. All users who click on headline A may be sent to site A. Similarly, all users who click on headline B may be sent to site B.

In another example, referral program and database 204 may select a content server based on a specific length of time. For example, all traffic may be distributed to one site for a week or other predetermined period, followed by distribution to another site.

Referral program and database 204 may also distribute click through traffic by geographic location of the user. This information may be determined based on the query received from the user's machine. For example, a live advertisement on a local newspaper's home improvement page may result in the user being sent to web sites containing home improvement articles sponsored by local home improvement stores.

Another method that referral program and database 204 may use to select a content server is through category. For example, live ads on Latino sites may send users to full content display on other Latino sites.

Headline and content program and database 200 simultaneously updates both headline content displays and full contents of articles. Such simultaneous updates can be performed using a Java applet located on a web site or using Hypertext Markup Language. Exemplary computer code for simultaneously updating headlines and full articles will be discussed in more detail below.

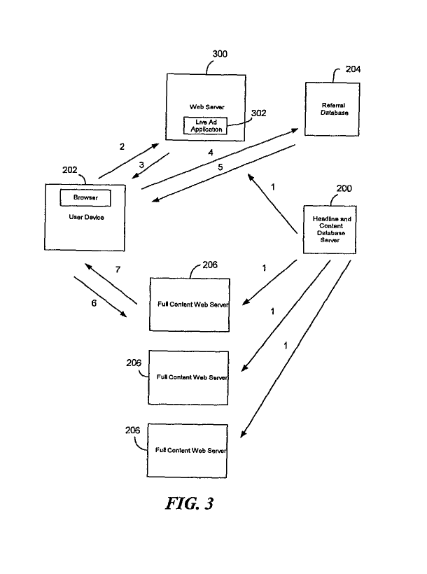

FIG. 3 is a message flow diagram illustrating the exemplary message flow between network entities in dynamically allocating click-through traffic and dynamically updating headline and content server content according to an embodiment of the present invention. In FIG. 3, entities 200, 202, 204 and 206 are the same as the correspondingly-numbered entities described with respect to FIGS. 1 and 2. Hence, a description thereof is not repeated herein. Newly-introduced entities in FIG. 3 web server 300 and live advertisement application 302. Web server 300 may serve a web site accessed by a number of users, such as an Internet service provider's home page or a search engine home page. Live advertisement application 302 is a program that displays a news or other headline to the user on the web page served by web server 300.

In the example illustrated in FIG. 3, it is assured that both headlines and content are updated periodically by headline and content program and database server 200. In order to update headlines and database content, first, in step 1, headline and content program and database server 200 sends a fresh news headline, such as “Congress Passes New Patent Law Reforms” to the live advertisement application 302 and concurrently sends the full content of the news article referenced by the news headline to a plurality of full content web servers. Step 1 may be performed periodically to update the headlines in the live advertisements and the corresponding full content on content servers 206.

As discussed above, live advertisement application 302 may use Java, XML, HTML code, or any other type of computer code capable of dynamically updating content on a web site. In one example, live advertisement application 302 places a tag on the web site where the live advertisement is to be displayed. This tag contains parameters that determine the format of the headlines that are displayed in the user's browser as well as a loop function that reloads the appropriate headlines from the live ad application each time the browser loads the web site.

In step 2, user device 202 sends a request for accessing a web page of interest using a browser. The web page may be a search engine home page, an Internet service provider home page, or any other web page of interest to the user. The request may include information regarding the user if the requested web site has stored a cookie on user device 202 based on a previous access to the same web site.

In step 3, web server 300, which serves the web page, sends the web page to user device 202 to be viewed using the browser. The web page includes the live advertisement which contains a current news headline.

In step 4, the user clicks on the live advertisement, which causes the user's browser to generate a query to referral program and database 204. The query contains information for identifying the live ad being requested. An example of such a query may be:

http://www.referral_database.com/patent_law_article.html

The query may also include a cookie received from the user's browser.

In step 5, referral program and database 204 determines which one of the full content web servers 206 will provide the content to the user. This selection may be performed using any of the examples described above. The referral database then sends the web address of the selected content server to the user's browser.

In step 6, the browser of user device 202 generates a query to the selected full content server.

In step 7, the selected full content server 202 serves the full content of the requested article to user device 202 through the browser.

Full content web server 206 may also display an e-commerce offer or itself display an advertisement that may be of interest to the user based on the user's interest in the article. In this example, the e-commerce offer may be a free trial subscription to a journal on patent law.

It will be understood that various details of the invention may be changed without departing from the scope of the invention. Furthermore, the foregoing description is for the purpose of illustration only, and not for the purpose of limitation—the invention being defined by the claims.

What is claimed is:

1. A method for dynamically allocating click-through traffic to a web site, the method comprising:
(a) providing, on first web site, an identifier for identifying a topic of interest to a user;
(b) receiving a user request for accessing full content associated with the identifier;
(c) dynamically selecting a first content web site containing the full content associated with the identifier based on a predetermined traffic allocation algorithm; and
(d) sending address information for accessing the first content web site to the user.

2. The method of claim 1 wherein providing an identifier on a first web site includes providing a news headline on the first web site.

3. The method of claim 1 wherein providing an identifier on a first web site includes providing an audio snippet on the first web site.

4. The method of claim 1 wherein providing an identifier on a first web site includes providing a video snippet on the first web site.

5. The method of claim 1 wherein providing an identifier on a first web site include providing and audio/video snippet on the first web site.

6. The method of claim 1 wherein providing an identifier on a first web site incudes providing a textual summary of a publication on the first web site.

7. The method of claim 2 wherein the full content is a news article associated with the news headline.

8. The method of claim 7 comprising dynamically updating the news headline on the first web site and the news article on the first content web site at predetermined time intervals.

9. The method of claim 3 wherein the full content is an audio file containing the audio snippet.

10. The method of claim 9 comprising dynamically updating the audio snippet on the first web site and the audio file on the first content web site at predetermined time intervals.

11. The method of claim 4 wherein the full content is a video file containing the video snippet.

12. The method of claim 11 comprising dynamically updating the video snippet on the first web site and the video file on the first content web site at predetermined time intervals.

13. The method of claim 4 wherein the full content is an audio/video file containing the audio/video snippet.

14. The method of claim 13 comprising dynamically updating the audio/video snippet on the first web site and the audio/video file on the first content web site at predetermined time intervals.

15. The method of claim 6 wherein the full content is the publication.

16. The method of claim 13 comprising dynamically updating the textual summary on the first web site and the publication on the first content web site at predetermined time intervals.

17. The method of claim 1 wherein dynamically selecting a first content web site further comprises the steps of:
(a) determining information regarding the user from the user request; and
(b) selecting the first content web site based on the information regarding the user.

18. The method of claim 1 wherein providing an identifier on a web site includes providing the identifier as a link included in an email message.

19. The method of claim 1 wherein providing an identifier on a first web site includes providing the identifier on a first web page and displaying the first web page on a computer display device.

20. The method of claim 1 wherein dynamically selecting the first content web site further comprises the steps of:
(a) sending a query to a referral database; and
(b) extracting the address information for the first content web site from the referral database.

21. The method of claim 1 wherein the steps are implemented by a computer program product comprising computer-executable instructions embodied in a computer readable medium.

22. A system for distributing click-through traffic to a content web site, the system comprising:
(a) a first server for displaying a content teaser for increasing user interest in accessing full content associated with the content teaser; and
(b) a referral database server for receiving input from the user for accessing the full content and for dynamically selecting a content web server for delivering the full content to the user.

23. The system of claim 22 wherein the first server is a web server adapted to display the content teaser on a web browser.

24. The system of claim 22 wherein the first server is an email server adapted to send the content teaser as an email attachment.

25. The system of claim 22 wherein the first server is a wireless web server adapted to send the content teaser to a wireless web device.

26. The system of claim 22 wherein the content teaser is a news headline and the full content is a news article represented by the news headline.

27. The system of claim 22 wherein the content teaser is an audio snippet and the full content is an audio file containing the audio snippet.

28. The system of claim 22 wherein the content teaser is a video snippet and the full content is a video file containing the video snippet.

29. The system of claim 22 wherein the content teaser is an audio/video snippet and the full content is an audio/video file containing the audio/video snippet.

30. The system of claim 22 wherein the content teaser is a textual summary and the full content is a publication represented by the textual summary.

31. The system of claim 22 comprising a headline and contents database server operatively associated with the first server and one of a plurality of content web servers for dynamically updating the content teaser and the full content.

32. The system of claim 22 wherein the referral database server is adapted to receive information regarding the user and to select one of a plurality of content web servers based on the information regarding the user.
